(19) United States
(12) Patent Application Publication
(10) Pub. No.: US 2023/0150868 A1
(43) Pub. Date: May 18, 2023

(54) OBJECT WITH ACTIVE ANTI-ADHESIVE SURFACE

(71) Applicant: Fraunhofer-Gesellschaft zur Förderung der angewandten Forschung eingetragener Verein, München (DE)

(72) Inventors: Ralph Wilken, Bremen (DE); Uwe Specht, Bremen (DE); Thomas Lukasczyk, Bremen (DE)

(21) Appl. No.: 17/916,183

(22) PCT Filed: Apr. 1, 2021
(86) PCT No.: PCT/EP2021/058603

§ 371 Date: Sep. 30, 2022

(30) Foreign Application Priority Data
Apr. 1, 2020 (DE) 10 2020 109 113.3

(51) Int. Cl. C03C 17/42; C03C 23/00

(52) U.S. Cl. CPC C03C 17/42; C03C 23/0025; C03C 2217/948; C03C 2217/732; C03C 2218/153

(57) ABSTRACT

Substrate with transparent outer layer, wherein a transparent interdigital structure is disposed between the substrate and the outer layer.

The invention relates to a substrate with transparent outer layer, wherein a transparent interdigital structure is disposed between the substrate and the outer layer. It further relates to the use of such a transparent outer layer in combination with a transparent interdigital structure for improving the cleanability and/or for reducing the adherence of contaminants and also for removing snow and ice and for imparting antifog properties. The invention relates, moreover, to a process for producing a coated substrate of the invention.

### PRIOR ART

Contamination of surfaces is undesirable in many sectors not only for esthetic reasons; instead, these contaminants often reduce or prevent the function of the article itself. The nature of the fowling or accumulations on surfaces is diverse: In regions of surfaces on buildings, it frequently takes the form of particles of natural materials such as, for example, dust, or alternatively deposits arising from environmental pollution, such as soot, for example. Biological growths, in the form of algae, for example, also occur. Such biological colonization of surfaces is a major factor particularly in the maritime sector, where increased colonization by the algae and even higher organisms, such as barnacles, for example, is observed for surfaces in contact with water.

Surface fowling is particularly critical for optical instruments, as it may affect or distort measurements or even render them impossible.

In the prior art there are a host of approaches to preventing or reducing accumulations on surfaces.

In the architectural sector, photocatalytic coatings are employed. The photocatalytic effect results in the breakdown of organic adsorbates and/or contaminations, which are cleaned off accordingly. Inorganic substances or particles cannot be removed by cleaning with this method.

In maritime travel, antifouling paints are employed in order to prevent the infestation of the hulls of ships by barnacles and other (micro)organisms (fuel consumption). The effect is often based on the release of growth-inhibiting material from the paint continuously, which is therefore released into the environment. These paints are frequently (tin- or) copper-based, and therefore entail high environmental pollution. Moreover, the low transparency of these coatings prevents them being used on transparent surfaces, as are present in optical instruments or windows, or portholes.

Alternating-current electrokinetics enables, through dielectrophoresis (DEP) and alternating-current electrothermy, by way of in general conductive interdigital structures, the maintenance of unobstructed surfaces or the removal of particles from surfaces. In an aqueous environment, the particles, in a nonuniform electrical field, are repelled by the substrate surfaces through a negative DEP effect and are transported away by a fluid flow as a consequence of alternating-current electrothermy. The electrical field is generated by a harmonized arrangement of electrodes (e.g., interdigital structures) [Hawari, A. H. [et al.]: A fouling suppression system in submerged membrane bioreactors using dielectrophoretic forces. In: Journal of environmental sciences (China) vol. 29, 2015, pp. 139-145. DOI: 10.1016/j.jes.2014.07.027], [Salari, A. [at al.]: AC Electrothermal Effect in Microfluidics: A Review (eng), Micromachines, vol. 10, No. 11, 2019, doi: 10.3390/mi10110762]. The particles thus repelled can be flushed from the surface with a stream of water (rain, water flow, etc.). A disadvantage with this method is that the interdigital structures required are not transparent and therefore cannot be used for optical/sensor/transparent applications.

By means of selective laser ablation using a femtosecond laser, transparent interdigital structures composed of indium tin oxide (ITO) layers can be produced on glass surfaces, for capturing particles by means of positive DEP [Xu, M. Y. [et al.]: “Heat accumulation effects in femtosecond laser ablation of ITO thin films for DEP trapping devices” in CLEO 2007, Baltimore, Md., USA, 2007, pp. 1-2, doi: 10.1109/CLEO.2007.4452443].

Disadvantages of the technique described in said document are as follows:
1. limiting aging stability (corrosion/ablation)
2. uneven transmission (through interference of the ITO layer)
3. undefined dielectric constant between conductor tracks of the interdigital structures, affecting the DEP effect
4. Increased power consumption (low efficiency) during DEP
5. susceptibility to infestation and fowling, especially in the region of the trenches generated by laser ablation

[Xu, M. Y. [et al.]: “Heat accumulation effects in femtosecond laser ablation of ITO thin films for DEP trapping devices” in CLEO 2007, Baltimore, Md., USA, 2007, pp. 1-2. doi: 10.1109/CLEO.2007.4452443] employs the DEP technique for a different purpose from that of adherence prevention: Here the primary aim is to increase the adherence of certain particles at particular points on a surface.

Against the background of the prior art, therefore, an object of the present invention was to provide surfaces which, taking account of optical requirements of the particular substrate, possess the possibility of improved prevention of adherence and/or improved partability of adherences, where there ought also to be improved stability of the desired function. An object preferably was for the surface in fact to possess improved prevention of adherence/cleanability relative to that possible with dielectrophoresis alone, and/or to enable reduced energy usage for the dielectrophoresis, without the need to accept reductions in the desired effect.

This object is achieved by means of a substrate with transparent outer layer, wherein a transparent interdigital structure is disposed between the substrate and the outer layer.

“Transparent” in the sense of the present invention means, in its broadest definition, that with the light incident perpendicularly to the surface, the transmission of at least one wavelength in the range between 250 nm to 11 μm is >30%. In case of doubt, this is to be checked in integral nanometer steps, beginning at 250 nm. Transparency in the sense of the present invention means preferably that the transmission of at least 10, more preferably at least 100, wavelengths in the range from 250 nm to 11 μm, to be checked in the above-described steps, is greater >30%. More preferably still, the transmission of two-thirds of the wavelengths (each in 1 nm steps) in a block 100 of adjacent wavelengths in the range from 250 nm to 11 μm is >30%. With particular preference, the transmission of two-thirds of the wavelengths (each in 1 nm steps) in a block 100 of adjacent wavelengths in the range from 380 nm to 780 nm is >30%.

The following definition of “transparent” is additionally valid for the purposes of this text, although preferably the definition valid is the transmission-based definition described in the preceding paragraph.

“Transparent” in the sense of the present invention means, in its broadest definition, that the absorption coefficient of at least one wavelength in the range between 250 nm to

$$11 μm is < 10 \times \frac{1}{cm} .$$

In case of doubt, this is to be checked in integral nanometer steps, beginning at 250 nm. Transparency in the sense of the present invention means preferably that the absorption coefficient of at least 10, more preferably at least 100, wavelengths in the range from 250 nm to 11 μm, to be checked in the above-described steps,

$$is greater < 10 \times \frac{1}{cm} .$$

More preferably still, the absorption coefficient of two-thirds of the wavelengths (each in 1 nm steps) in a block 100 of adjacent wavelengths in the range from 250 nm to

$$11 μm is < 10 \times \frac{1}{cm} .$$

With particular preference, the absorption coefficient of two-thirds of the wavelengths (each in 1 nm steps) in a block 100 of adjacent wavelengths in the range from 380 nm to

$$780 nm is < 10 \times \frac{1}{cm} .$$

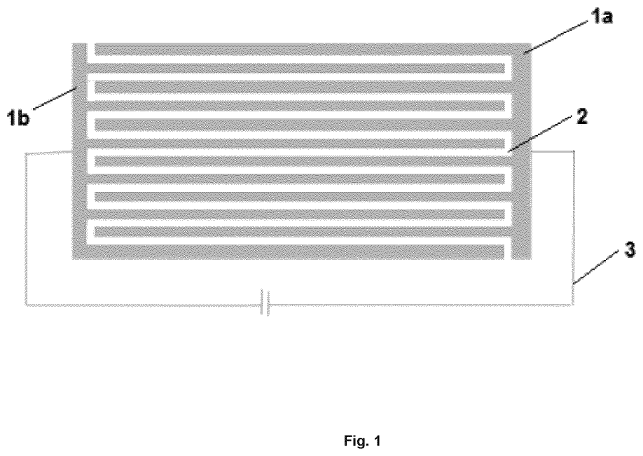

An example of an interdigital structure in the sense of the present text is that of FIG. 1. With reference to FIG. 1, the term “interdigital structure” is defined for this text below: an interdigital structure consists of at least two interim engaging but not mutually contacting electrodes (1a, 1b). These electrodes each have at least two conductors, which are electrically connected (3) only at one conductor end and which have a sufficient spacing region (2) from one another to provide at least one conductor of the or one of the other electrodes (1a, 1b), between the two conductors, with sufficient space, so that there is no electrical contact between the at least two electrodes.

The length of the conductors is greater by a multiple than the width of the conductors (≥factor 2, more preferably ≥factor 10). The width of the conductor is greater by a multiple than the height of the conductors (≥factor 2, more preferably ≥factor 5). The height of the conductors is substantially the same. The distance between the non-mutually contacting conductors is preferably substantially the same or, in order to generate a directed fluid flow as a consequence of the electrohydrothermal excitation of conductor fluids, the electrode spacing and the electrode width alternate with wide electrode, wide spacing to the adjacent narrow electrode with narrow spacing to the next in turn wide electrode, and so on. The base areas of all the electrodes are located preferably in the same area. This area may be planar or else curved. The conductors may be linear or curved.

“So that there is no electrical contact between adjacent electrodes” means in the sense of the present invention that the electrodes are not conductively connected to one another. The outer layer takes on the function of an electrical insulator on the electrodes, thereby hindering exchange of charge between the electrodes and surrounding media, e.g., liquids. Between the electrodes there is likewise a material disposed which exerts an insulator function. According to Paul, S.; Paul, R.: Grundlagen der Elektrotechnik und Elektronik 1. [Principles of electrical engineering and electronics 1.], Berlin, Heidelberg (2010): Springer Berlin Heidelberg, 10.1007/978-3-540-69078-8, an insulator, also called a nonconductor or dielectric, is defined such that they ideally possess no freely mobile charge carriers. The resistivity of insulators is greater than 10⁸ ohm cm. This definition is likewise valid for this text.

An “outer layer” in the sense of the present specification is always a layer applied such that it constitutes the outermost layer of the coated substrate; moreover, the skilled person understands that an outer layer in the sense of the present specification is always a sheetlike structure, in other words, in particular, a structure that covers not only the conductor tracks of the interdigital structure.

Surprisingly it has emerged that it is possible to generate transparent interdigital structures in the sense of the present invention in combination with transparent outer layers. Having emerged as being particularly suitable for this purpose is a process in which the region of the (future) interdigital structure on the surface of the substrate is coated extensively with a material suitable for the interdigital structure, after which the conductor tracks of the interdigital structure are generated by chemically or physically working the spacer regions between the conductor structures, more particularly using lasers, in such a way that there is an electrical insulation between the conductors. This may be accomplished, optionally with inclusion of material from the substrate in the spacer regions, by chemically or physically modifying the material for the interdigital structure and/or with local removal or thickness reduction of the material present in the (future) spacer regions, more particularly by means of a laser or through a chemical procedure. Reference in this regard may also be made to text later on below.

With this technology and the selection of a suitable outer layer, it is surprisingly uncomplicatedly possible to produce the substrate of the invention.

The combination of transparent outer layer and transparent interdigital structure in accordance with the invention therefore enables the advantages of the interdigital structure to be utilized for all applications dependent on transmissibility of one or more wavelengths in the region of the coating on the substrate. Optical instruments in particular, but also any substrate surface for which “translucency” for at least one wavelength range is desirable, maybe effectively protected from unwanted adherences, or designed such that such adherences are more easily removed by cleaning, with the coating system for use in the Invention.

It is not necessary here for voltage to be applied permanently to the interdigital structure. Hence it is conceivable, for example, for the interdigital structure to be provided with voltage, preferably alternating-current voltage, when a cleaning process is to be initiated (or is just possible), resulting in alternating fields which repel particles and fouling which have accumulated on the surface of the transparent outer layer. As and when required it is of course also possible for the interdigital structure to be provided permanently with electrical (alternating-current) voltage.

The following two paragraphs, relating to dielectrophoresis and to alternating-current electrothermy, have been based on: Salad, A. [et al.]: AC Electrothermal Effect in Microfluidics: A Review. In: Micromachines 10 (11).2019. DOI: 10.3390/mi10110762.

The force effect of dielectrophoresis arises through the interaction between the induced dipole moment of a particle and a nonuniform electrical field. The nonuniform field is brought about by the electrodes and is influenced by the geometric arrangement of the electrodes, by the electrode properties themselves, and by the outer layer, and also by the permittivity of the surrounding medium. For particles with relatively low polarizability, a force will act in the direction of regions having a low electrical field (negative DEP). The DEP force on particles decreases with the gradient of the field. The resulting particle velocities are in inverse proportion to the third power of the distance. Therefore only thin insulating layers are suitable for encapsulating the electrodes.

Alternating-current electrothermy results from the interaction of a nonuniform electrical field with a temperature gradient in the mass of the field. The temperature gradient within the liquid produces local differences in the electrical properties of the liquid, i.e., conductivity and permittivity, which induce a free charge density. The source of the temperature gradient may be internal (e.g., Joule heating) or external (e.g., strong illumination, microheaters, etc.). The effect of the alternating-current electrothermy thus originates from a temperature gradient in the mass of the liquid and not from the liquid-electrode interface. With alternating-current electrothermy it is possible to generate strong microflows in particular in liquids having high conductivities of more than 0.7 S/m. The use of symmetrical electrode pairs in the context of the present invention produces induced symmetrical microvortices above the electrodes, so that no net flow is generated. For a directed net flow it is preferred in the invention to break the symmetry of the electrodes. Since the electrothermy force is a function of the electrical field and of the temperature gradient, the asymmetry may be achieved by manipulating one or both factors.

In this sense it is preferred for the effects of the substrate of the invention, in the sense of the objective described above, to arise not primarily through formation of heat within the structure (that is, beneath the outer layer plane) or by acoustic effects. Preferred in the sense of the present invention is a substrate of the invention with transparent outer layer, wherein the transparent outer layer is a layer deposited from the gas phase or a sol-gel layer, preferably a layer generated by means of physical or chemical vapor deposition, more preferably by means of plasma-enhanced physical or chemical vapor deposition.

Alternatively preferred in the sense of the present invention is a substrate of the invention with transparent outer layer, wherein the transparent outer layer or interlayer is a silicone layer, preferably a layer containing surface-modified silicone, more preferably radiation-modified silicone, especially preferably as disclosed in WO 2016/030 183 A1. Reference should be made in particular here to the configuration of the silicones disclosed in that specification in the claims and the specific examples. With this preferred coating process it is possible to generate, effectively, the transparent outer layers for use in the invention. When selecting the appropriate method of disposition, the skilled person will also take into account the desired properties of the transparent outer layer, particularly in respect of the intended use of the coated substrate.

The following methods are preferably suitable, Illustratively, for generating the respective property of the outer layer, though this should not be considered to impose any limitation:
Photocatalysis: physical vapor deposition, chemical vapor deposition, optionally with subsequent heat treatment for the deposition of photocatalytic titanium dioxide, more particular in the anatase modification
Mechanical protection: sol-gel coating, plasma-enhanced chemical vapor deposition for the deposition of hard Si oxide layers or plasma-polymeric, silicon-containing coatings
Anti-stick effect: plasma-enhanced chemical vapor deposition for depositing plasma-polymeric, silicone-containing coatings with low surface energy, preferably <22 mN/m
Electrical insulation effect: sol-gel coating (advantage: formation of coatings with low defect count)/aluminum-containing coatings or silicone-containing coatings deposited by plasma-enhanced, chemical vapor deposition
Reinforcement of the dielectrophoretic effect: physical vapor deposition, chemical vapor deposition for the deposition of titanium-containing coatings.

Preferred in the invention is a substrate of the invention with transparent outer layer wherein the transparent outer layer comprises in summation ≥85 at % of Si, C, F and O, preferably ≥90 at % of Si, C, F and O, more preferably ≥95 at % of Si, C, F and O or in summation ≥85 at % of Ti and O, preferably ≥90 at % of Ti and O, more preferably ≥95 at % of Ti and O, or ≥85 at % of Al and O, preferably ≥90 at % of Al and O, more preferably ≥90 at % of Al and O, measured by means of XPS and based on the atoms detected by means of XPS.

In summation, here means that the sum of the fractions of the subsequently recited elements produces the respective value.

The preferred layer compositions for the transparent layer represent organosilicon or organic transparent outer layers, more particularly plasma-polymeric transparent outer layers, it being further preferred for the faction of silicone in these layers to be at least 5 at % In the sense of the definition above. Organosilicon layers here are preferably fluorine-free.

An alternative preferred outer layer is a layer based on titanium oxides, more particularly of titanium dioxide. A further alternative here is a transparent layer of this kind that is based on aluminum oxides.

The indication that a layer is “based” on a particular material means here, in the sense of the present text, that the material in question comprises the stated compound (or group of compounds) to an extent of at least 50%, more preferably at least 70%, more preferably at least 90%, it even being preferable for the material in question to consist of the compound or group of compounds.

A “group of compounds” in the sense of the above definition consists here of those compounds which fall within the general definition. An example of this are “titanium oxides”, which comprises the group of al the titanium dioxides and suboxides of titanium in all crystal structures.

It has emerged that the stated preferred materials for the outer layers are particularly suitable for generating outer layers which on the one hand are transparent yet on the other hand also possess further desirable properties, described further below.

Preferred is a substrate of the invention with transparent outer layer, wherein the interdigital structure consists of a material based on a composition selected from the group consisting of indium tin oxide, zinc oxide, fluorine tin oxide, aluminum zinc oxide, antimony tin oxide, electrically conductive transparent varnish, and graphene, preference being given to indium tin oxide.

It is generally the case in the context of the present invention that undoped zinc oxide is the least preferred material for the interdigital structure, and in the case of doubt can preferably be excluded from the aforesaid group. It has emerged that particularly effectively transparent interdigital structures can be produced from the stated materials. This is especially the case if the preferred process of the invention, described later on below, is employed.

Preferred is a substrate of the invention with transparent outer layer, wherein the thickness of the interdigital structure is 10 nm-10 μm, preferably 20 nm-1 μm and more preferably 30 nm-500 nm and/or wherein the thickness of the outer layer is 50 nm-10 μm, preferably 100 nm-5 μm and more preferably 200 nm-3 μm.

“Thickness” here refers to the mean thickness of the interdigital structure or of the (extensive) outer layer, respectively.

It has emerged that with these preferred ranges for the thickness of the interdigital structure or the thickness of the outer layer, the aim of lowering the adherence of unwanted particles and/or microorganisms or increasing the cleanability can be achieved in a particularly effective way.

Preferred is a substrate of the invention with transparent outer layer, wherein the interstices between the conductors of the interim engaging electrodes of the interdigital structure are filled at least partly with material resulting from the material of the interdigital structure “Material resulting from the material of the interdigital structure” here means that the material in question has been transformed and/or chemically modified during the generation of the interdigital structure itself. This material then occupies at least partly, with reference to FIG. 1, the space (2) between the interdigital structures. This means in turn that the interdigital structure for preferred use in the invention has been generated not from a purely ablative process, but rather a process which (also) transforms the material of which the interdigital structure consists, the transformation being preferably such that there is Insulation between the conductive tracks of the individual electrodes of the interdigital structure. In this case it is of course possible for the generation of the interdigital structure to be able to take place partly with ablation and partly with corresponding transformation. Such transformations here are. In particular, chemical modifications, such as, for example, oxidations and enrichments or depletions with individual elements, or physical modifications, such as recrystallizations, for example.

If not all the material is ablated from the space between the individual electrodes of the Interdigital structure, this has the advantage in particular that the subsequent coating with the outer layer is more uniform. The elevations represented by the electrodes of the interdigital structure relative to the space between them are at least partly level as a result. As a result of this, the transparent layer, particularly if it has been generated in a physical vapor deposition process (PVD process), chemical vapor deposition process (CVD process) or plasma-enhanced chemical vapor deposition process (PE-CVD process).

At the same time, the presence of material resulting from the material of the interdigital structure in the interstices of the interdigital structure suggests a particularly suitable production process for the interdigital structure (cf. later on below).

Preferred is a substrate of the invention with transparent outer layer, wherein the outer layer is completely closed in the region of the interdigital structure.

As a result, the outer layer is able in particular to fulfil a protective function; it means that, given suitable configuration of the outer layer, the interdigital structure is electrically insulated to the outside, this being important particularly in the context of uses involving water contact, and it is able to fulfil its preferred additional functions in a particularly suitable way (cf. also later on below).

Preferred is a substrate of the invention with transparent outer layer, wherein the interdigital structure is disposed exactly in one plane between the substrate and the outer layer.

“Exactly in one plane” in the sense of this text means that the base areas of all the electrodes of the interdigital structure lie in the same area. This area may be planar or else curved.

The advantage of disposing the interdigital structure exactly in one plane is that particularly uniform (alternating) fields can be generated as a result. It is therefore possible to provide the surface of the coated substrate with a uniform repulsion force for unwanted depositions. Moreover, the disposition in one plane enables easier production of the anti-stick surface of the invention. The interdigital structure itself, furthermore, can be produced particularly effectively in this way. Multiple planes for the construction of one or more interdigital structures would lead to a significantly more complicated lamellar construction, which would require a multiplication of process steps.

Preferred is a substrate of the invention with transparent outer layer, wherein the outer layer has one or more of the following functions:
mechanical protection for the interdigital structure,
chemical protection for the interdigital structure,
electrical insulation of the interdigital structure,
increasing the dielectric constant of the coating of the substrate,
adapting the transmission or reflectivity of interdigital structure and the material in the interstices of the interdigital structure for at least one wavelength, preferably for the range of visible light,
reducing the reflection,
reducing the adherence of microorganisms,
reducing the adherence of fowling, and
photocatalytic effect.

It is preferred here for the transparent outer layer to have 2, 3, 4 or more of the stated functions.

Mechanical protection for the interdigital structure here means that the outer layer possesses a structure which is more resistant than the interdigital structure to abrasion and preferably to other mechanical stress.

Chemical protection for the interdigital structure means, analogously, that the outer layer possesses a configuration which makes it more resistant, as compared with the interdigital structure itself, to the customary chemical attacks on the interdigital structure, preferentially, therefore, attacks by water, acids, bases and/or oxygen, solvents.

Electrical insulation of the interdigital structure here means that the coating is configured such that when a direct voltage is applied to an electrode of the interdigital structure, preferably no direct current, or at most a direct current smaller by a factor of 10, flows from the interdigital structure through the outer layer to the surrounding median, preferably water. This has the advantage that, Insofar as the interdigital structure is subjected to voltage, current losses are prevented or at least substantially reduced. Moreover, the interdigital structure with such a coating can be operated reliably even in waters with a relatively high salt content and consequently a higher conductivity of the surrounding medium.

Increasing the dielectric constant of the coating of the substrate means that the outer layer increases the dielectric constant of the overall coating of the substrate. This has the advantage that the desired repulsion effects are higher on the basis of an increased dielectric constant for the same voltage, leading to energy saving.

Adapting the transmission or reflectivity of interdigital structures and the material in the interstices of the interdigital structure for at least one wavelength here means that the outer layer reduces the differences between transmission and/or reflectivity of the material of the Interdigital structure and of the material in the interstices of the interdigital structure, measured from the outside of the outer layer. Particularly in the region of visible light, the Interdigital structure frequently means that there are differences in color and/or transmission between the interdigital structure and the interstices. Through the selection of a suitable transparent outer layer, this is possible in respect both of the physical composition and of the layer thickness in the preferred coated substrate of the invention.

Reducing the reflection here means that transmission of the layer system on the substrate is improved (increased). Reducing the reflection here preferably does not mean that a reflection occurring on the substrate is reduced. The advantage of reducing the reflection is to be seen in particular in the possibility for a higher light yield, or an increased yield in the range of the desired wavelength.

Reducing the adherence of microorganisms here means that microorganisms (here, exceptionally, higher organisms are also included) are hindered from accumulating more strongly by the outer layer, even when the interdigital structure is not subject to voltage.

Reducing the adherence of fouling is to be understood here in analogy to the definition of reducing an adherence of microorganisms.

Both latter reductions are centrally desirable in the sense of the present invention, on the one hand to preserve the visual appearance and on the other hand, in particular, to maintain the functionality.

Photocatalytic effect in the sense of the present invention means that catalysis reactions are able to proceed on the surface of the outer layer under the influence of radiation in the wavelength range as defined above for transparency. This has advantages in particular if it results in preferential breakdown of organic adsorbates, filmic contaminants and/or adhering particles. Layers according to WO 2019/121 887 A1 or WO 2009/121 970 A2 may preferably be used in order to achieve antimicrobial and/or biocidal properties.

Layers according to WO 2019/121 518 A1 may preferably be used in order to achieve corrosion control, protection from chemical attack, the improvement in cleanability, the improvement in cleanability, as release layer and/or as antiscratch protection.

Layers according to WO 2018/010 987 A1 may preferably be used to achieve corrosion control and/or protection from chemical attack.

Layers according to WO 2015/044 247 A1 may preferably be used to achieve corrosion control, protection from chemical attack, the improvement in cleanability, the improvement in cleanability, and/or antiscratch protection or to function as a release layer.

Layers according to WO 2011/061 339 A1 or WO 2009/153 306 A1 may preferably be used in order to reduce the coefficient of sliding friction or the surface energy and/or to improve the abrasion resistance and/or tactility.

Layers according to WO 2010/125 178 A1 may preferably be used to achieve corrosion control and/or protection from chemical attack.

Layers according to WO 2010/089 333 A1 may preferably be used to achieve the Improvement in cleanability and/or antiscratch protection or to function as a release layer and/or to reduce the surface energy.

Preferred is a substrate of the invention with transparent outer layer, wherein a transparent interlayer is disposed between the outer layer and the substrate, and has one or more of the following functions:
mechanical protection for the interdigital structure,
chemical protection for the interdigital structure,
electrical insulation of the interdigital structure,
adapting the transmission or reflectivity of interdigital structure and the material in the interstices of the interdigital structure for at least one wavelength, preferably for the range of visible light,
reducing the reflection,
increasing the dielectric constant of the coating of the substrate, and
improving the adhesion within the coating and/or of the coating with the substrate.

The definitions of the function of the interlayer are subject to the statements made above for the outer layer, analogously.

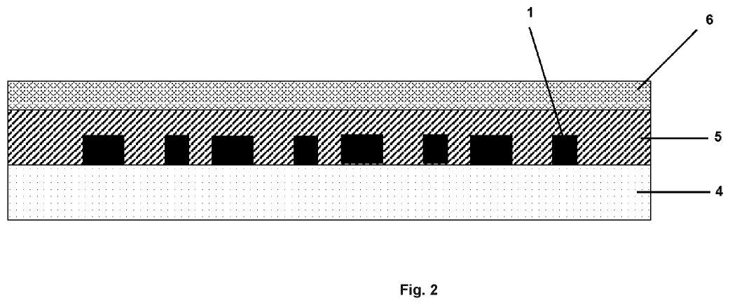

FIG. 2 represents schematically a substrate of the invention with transparent outer layer and interlayer.

The reference numerals here denote the following:
1 The interdigital structure (including both electrodes (1a. 1b)).
4 Substrate
5 interlayer, the interlayer here also including the material (2) in interstices in the interdigital structure (1a, 1b). The material (2) In the interstices in the interdigital structure here may be the same material as that of the interlayer on the electrodes in the interdigital structure, or may be a different material.
6 Outer layer

The advantage of an interlayer for use preferably in the invention, as well as the additional improvements of function, is also in particular that by means of a suitable interlayer it is possible to achieve improvements in function that might possibly not be achieved by a suitable outer layer, or at least not additionally. Thus, for example. It may be the case that the outer layer serves above al for mechanical protection, whereas the interlayer produces insulation for the interdigital structure or ensures an improvement in adhesion between outer layer and interdigital structure.

The skilled person has a multiplicity of materials available in order to impart the desired properties to the respective outer layer or interlayer. In the sense of the present invention, however, it is necessary to ensure that both layers (if both are used) are transparent in the sense of the present definition. It is surprising in this context that through the combination of the corresponding layers with the interdigital structures, in spite of the requirement of transparency, it is possible to achieve additive effects, in relation to cleanability and reduced adherence, for example, and also combinations of effects, such as improvement of cleanability and saving of the requisite energy demand, for example.

Preferred in the invention is a substrate with transparent outer layer, wherein the substrate is transparent or reflective on its surface.

Reflective in the sense of this text means here that the reflectivity for at least one wavelength, with light incident perpendicularly to the surface, in the wavelength range from 250 nm to 11 μm is ≥70%. For the preferred definitions for “reflective” and also for the determination, the statements made in the definition for “transparency” are valid analogously.

Particularly preferred in the invention is a layer construction in which the interlayer comprises a layer with high dielectric constant, preferably titanium oxides, and the outer layer comprises a hydrophobic, silicone-containing coating having a water contact angle >90°, preferably a plasma-polymeric, silicone-containing coating. The layer thickness of the Tioxide interlayer is preferably between 100 nm and 1 μm. The layer thickness of the hydrophobic outer layer is preferably between 10 nm and 500 nm.

A substrate which is transparent on its surface here may be, for example, an optical instrument; a substrate which is reflective on its surface may be, for example, a surface—of a component, for example—that is given visual appeal.

Preferred substrates of the invention with transparent outer layer, accordingly, are those selected from the group consisting of optical component, preferably window, lens, mirror, display, especially for the maritime sector, building outer skin or part thereof, vehicle part, preferably headlamp, indicator, sensor, window or mirror, dishware, (road) sign, illuminant, sensor, sensor housing, medical instrument, transparent surfaces for photovoltaics, aquarium, camera lenses, bioreactors, glasshouses, especially insides of glasshouses.

It should be borne in mind here that in the sense of the present text, a building outer skin may refer to the outer face of other edifices as well, such as, for example, bridges, quay walls, etc.

With these preferred substrates of the invention, the combination of transparency and soil adherence reduction and/or facilitated cleaning can be used to particularly advantageous effect.

Also part of the invention is the use of a transparent outer layer in combination with a transparent interdigital structure, in each case as defined above, preferably in the respectively preferred forms, for improving the cleanability and/or for reducing the adherence of contaminants, more particularly microorganisms.

The use of the coated interdigital structure through application of a preferably high-frequency alternating field represents an essential core of the invention. It makes it possible—without being bound to any theory—through utilization of the negative dielectrophoretic effect, for unwanted adherences to be able either not to adhere on the surface of the substrate (in the actual sense, on the surface of the outer layer) and/or for adherences to be able to be parted and rinsed away and/or for adherences to be able to be removed more easily. The dielectrophoretic effect may be combined with or supplemented by the effect of alternating-current electrothermy, as a result of which, by flow excitation of the surrounding fluid, unwanted adherences can either not adhere on the surface of the substrate (in the actual sense, on the surface of the outer layer) and/or adherences can be parted and rinsed away and/or adherences can be removed more easily.

In the context of the use according to the invention, it is possible here for the interdigital structure to be exposed to voltage both permanently and also only temporarily. Hence, for example, in the case of building shells it is appropriate to apply a voltage only when the cleaning effect, by natural rain, for example, is present anyway. The voltage can of course also be switched on in the context of an active cleaning operation.

Also part of the invention is the use of a transparent layer in combination with a transparent interdigital structure in each case as defined above, preferably in the respectively preferred forms, for removing snow and ice and/or for imparting antifog properties.

“Antifog properties” in this context means that on condensation of supersaturated water vapor on a surface, the formation of water droplets is reduced, and ideally prevented. This is brought about, generally speaking, effectively by an improvement (increase) in the hydrophilic properties of the surface, particularly by an increase in the surface energy. In the case of the surface according to the invention, the wettability of the surface by water may be increased by means of the electrical fields generated.

Where heat is necessary for the prevention of accumulation/removal of materials such as snow and ice, for example, it may also be generated by electrical action on the interdigital structure (additionally to the rest of the effects).

Part of the invention is a process for producing a coated substrate of the invention, comprising the steps of:
a) providing a substrate, preferably as defined above as preferred,
b) generating a transparent interdigital structure, preferably as defined earlier on above as preferred, and
c) coating the substrate and the interdigital structure with a transparent outer layer, preferably as defined earlier on above as preferred.

The coated substrates of the invention are produced with this process. It is preferred here for step b) to take place at least partly by means of an ablation process, and/or by means of material conversion, preferably by means of a laser process, preference being given to the use of a laser having a wavelength in the near-IR range, more particularly an NdYAG laser, very preferably an NdYAG laser with flat-top profile.

It has emerged that in the sense of the present invention it is particularly useful if a substrate is employed that is at least partly coated with a closed layer of a material suitable for a digital structure. The desired interdigital structure can be generated subsequently in this material. In this context, various processes are conceivable in principle—for example, in analogy to photolithography, an irradiation, where those regions that are not to be removed or not to be modified, i.e., the regions of the actual interdigital structure, are covered by masking.

A simple and particularly effective method here is to generate the interstices between the electrode tracks of the interdigital structure by means of laser irradiation. For these interstices it is critical that they are configured such that there is sufficient insulation present between the individual electrodes of the interdigital structure. It is possible in principle here to ablate the material in the interstices (ablation) with the laser radiation or to transform it in such a way that the desired insulation characteristic is present. Particularly preferred processes utilize a mixture of both effects (ablation and material transformation). This has the advantage, among others, that the topographical differences on the surface between conductor track and interstice do not become too great. It has surprisingly emerged here that for the corresponding process, a laser in the near-IR range is particularly suitable, more particularly an Nd:YAG laser, more particularly an Nd:YAG laser with flat-top profile.

Preferred in the invention is a process of the invention wherein, after step a) and/or before step c), an interlayer is applied preferably an interlayer as defined earlier on above as preferred.

The advantages of the interlayer are described above. Through the presence of an additional interlayer, it is possible not only to improve the adhesion characteristics of the outer layer for use in the invention on the interdigital structures and/or of the interdigital structures on the substrate; instead, it may also be possible to achieve further improvements in properties, or additional effects, which could not be achieved, or not so effectively, from a combination of outer layer and interdigital structure alone. An example that may be given here is that, in the case of a suitable configuration of the interlayer, the entire layer system possesses an improved—that is, increased—total dielectric constant. The skilled person is then given a freer hand for configuring the outer layer for the purpose of achieving another preferred property, such as, for example, an increase in the mechanical protection or a reduction in the adherence of fouling.

Preferred in the invention is a process of the invention, wherein step c) takes place by a spray, immersion, PVD, CVD or PE-CVD process, preferably by a PVD, CVD or PE-CVD process.

These processes are—as already described above—particularly suitable for imparting the desired properties to the outer layer. Available to the skilled person for this purpose is a multitude of literature, allowing them to take suitable measures.

A number of further indications in relation to the interdigital structure may be given hereinafter it is self-evident that the interdigital structure must consist of a material which is conductive. The sheet resistance of the conductive coating is preferably <200 ohms, more preferably <100 ohms, more preferably <50 ohms, very preferably <20 ohms. In that case that there is transport of electrons, preferably without alteration of the material. The interdigital structure may be implemented, for example, in inductor material or semiconductor material, more particularly doped semiconductor material or in a combination of these two materials.

The bridge widths and bridge spacings are designed by the skilled person according to the size, geometry and composition (dielectric constants) of the anticipated particle fouling or organisms (biofouling) and of the field distribution which forms from the electrode geometry.

The bridge lengths are configured by the skilled person according to electrical conductivity of the electric conductive layer. Particularly long bridges are advantageous in this case, in order to provide maximum-sized areas rationally with the antifouling effect.

The number of bridges in the interdigital structure ultimately determines the area which is to be protected from fouling.

The regions of the substrate that do not have interdigital structures are positioned preferably at the edge of the substrate and may serve for the supply of voltage to the interdigital structure.

In order to be able to ensure the functioning of the interdigital structure even under water (minimal energy consumption), the interdigital structure is preferably coated extensively, preferably with a TiOₓ coating. In this case only suitable contacting points are not provided with the TiOₓ coating (through masks, for example) or the coating at these locations is subsequently removed again.

Through application of a suitable alternating-current voltage to the two contacting points, it is possible to remove the particles lying on the surface.

### EXAMPLE

Use of a glass substrate (25×25×1.1 mm; float glass) with a 120 to 160 mm ITO layer, supplier Sigma Aldrich, product number 703192. The sheet resistance R_{S}=8-12 ohms, the transmission T is 84% (at 550 nm).

Laser treatment took place with an Nd:YAG laser as follows:

Operating parameters: type: 300 W Nd:YAG laser (type CL300 from CleanLaser, Herzogenrath, Germany with Stamp Optic f(100) f-theta lens) and flat-top profile; repetition frequency f=40 kHz; power P=120 W; velocity v=4590 mm/s, spot size 459 μm.

Traversal of the meandering track in analogy to FIG. 1 with a line offset of 750 μm and a length of 2 cm.

The width of the individual conductors of the two electrodes results as being 375±18 μm.

The spacing between the conductors of the individual electrodes is likewise 375+−18 μm.

The surface thus obtained shows the following elemental compositions, measured by means of XPS:

| | C | O | Si | In | Sn |
|---|---|---|---|---|---|
| | (at %) | (at %) | (at %) | (at %) | (at %) |
| ITO-coated glass | 41.6 | 37.1 | — | 18.8 | 2.5 |
| in relations without | | | | | |
| laser treatment | | | | | |
| ITO-coated glass | 12.6 | 56.5 | 12.6 | 16.5 | 1.7 |
| in relations with | | | | | |
| laser treatment | | | | | |

The laser treatment results in a partial laser ablation with a depletion of the tin with the simultaneous presence of the elements from the substrate.

Coating of the resultant structure with a TiO₂ layer as per patent application DE 10 2013 215 835 A1 with a layer thickness of 250 nm, with the following parameters:
coating construction: treatment under atmospheric conditions without encapsulated system; only one feed was used for the titanium-containing precursor; the residual moisture in the atmosphere served as a coreactant
titanium precursor: titanium isopropoxide (CAS: 546-68-9; manufacturer: ABCR; purity: 97%)
carrier gas for titanium precursor: nitrogen 5.0, 5 l/min
amount of titanium precursor: 10 μl/min
precursor nozzle: steel tube with 4 mm internal diameter
sample patterning: meandering (movement of the sample beneath the stationary nozzle)
line spacing for sample patterning: 4 mm
sample velocity: 1.7 m/min
number of coating cycles: 10
sample temperature during coating: 40° C. (heat treatment via hotplate)
coating nozzle spacing: 30 mm;
coating nozzle angle: 0° (perpendicular to sample):

The substrate with coating was transparent for visible light.

The structure produced was tested in an aquarium (T=18° C.) with magnetic stirring+stirrer bar.

The generated structure was operated with a voltage of 30 V_{RMS} and a frequency of 1 kHz to 1000 kHz with linear increase in a cycle of 1 hour. After 10 days, the surfaces according to the invention exhibited 50% lower adherence of algae relative to an uncoated substrate, and 20% lower adherence of algae relative to a substrate with coated interdigital structures without voltage supply.

1. A substrate (4) with transparent outer layer (6), wherein a transparent interdigital structure (1a, 1b) is disposed between the substrate (4) and the outer layer (6).

2. The substrate (4) with transparent outer layer (6) of claim 1, wherein the transparent outer layer (6) is a layer deposited from the gas phase or a sol-gel layer, preferably a layer generated by means of physical or chemical vapor deposition, more preferably a layer generated by means of plasma-enhanced physical or chemical vapor deposition, or a silicone layer.

3. The substrate (4) with transparent outer layer (6) of claim 1 or 2, wherein the transparent outer layer (6) comprises in summation ≥85 at % of Si, C, F and O, preferably ≥90 at % of Si, C, F and O, more preferably ≥95 at % of Si, C, F and O or ≥85 at % of Ti and O, preferably ≥90 at % of Ti and O, more preferably ≥95 at % of Ti and O, or in summation ≥85 at % of Ai and O, preferably ≥90 at % of Al and O, more preferably ≥90 at % of Al and O, measured by means of XPS and based on the atoms detected by means of XPS.

4. The substrate (4) with transparent outer layer (6) of any of the preceding claims, wherein the interdigital structure (1a, 1b) consists of a material based on a composition selected from the group consisting of indium tin oxide, zinc oxide, fluorine tin oxide, aluminum zinc oxide, antimony tin oxide, electrically conductive transparent varnish, and graphene, preference being given to indium tin oxide.

5. The substrate (4) with transparent outer layer (6) of any of the preceding claims, wherein the thickness of the interdigital structure (1a, 1b) is 10 nm-10 μm, preferably 20 nm-1 μm and more preferably 30 nm-500 nm and/or wherein the thickness of the outer layer (6) is 50 nm-10 μm, preferably 100 nm-5 μm and more preferably 200 nm-3 μm.

6. The substrate (4) with transparent outer layer (6) of any of the preceding claims, wherein the interstices (2) between the conductors of the interim engaging electrodes of the interdigital structure (1a, 1b) are filled at least partly with material resulting from the material of the interdigital structure (1a, 1b).

7. The substrate (4) with transparent outer layer (6) of any of the preceding claims, wherein the outer layer is completely closed in the region of the interdigital structure (1a, 1b).

8. The substrate (4) with transparent outer layer (6) of any of the preceding claims, wherein the interdigital structure (1a, 1b) is disposed exactly in one plane between substrate (4) and outer layer (6).

9. The substrate (4) with transparent outer layer (6) of any of the preceding claims, wherein the outer layer (4) has one or more of the following functions:
mechanical protection for the interdigital structure (1a, 1b),
chemical protection for the interdigital structure (1a, 1b),
electrical insulation of the interdigital structure (1a, 1b),
increasing the dielectric constant of the coating of the substrate (4),
adapting the transmission or reflectivity of interdigital structure (1a, 1b) and the material (2) in the interstices of the interdigital structure (1a, 1b) for at least one wavelength, preferably for the range of visible light,
reducing the reflection,
reducing the adherence of microorganisms,
reducing the adherence of fowling, and
photocatalytic effect
and/or
wherein a transparent interlayer (5) is disposed between the outer layer (6) and the substrate (4), and has one or more of the following functions:
mechanical protection for the interdigital structure (1a, 1b),
chemical protection for the interdigital structure (1a, 1b),
electrical insulation of the interdigital structure (1a, 1b),
adapting the transmission or reflectivity of interdigital structure (1a, 1b) and the material (2) in the interstices of the interdigital structure (1a, 1b) for at least one wavelength, preferably for the range of visible light,
reducing the reflection,
increasing the dielectric constant of the coating of the substrate (4), and
Improving the adhesion within the coating and/or of the coating with the substrate (4).

10. The substrate (4) with transparent outer layer (6) of any of the preceding claims, wherein the substrate (4) Is transparent or reflective on its surface.

11. The use of a transparent outer layer (6) In combination with a transparent interdigital structure (1a, 1b) as defined in any of the preceding claims for improving the cleanability and/or for reducing the adherence of contaminants, more particularly microorganisms, and/or for removing snow and ice and/or for inparting antifog properties.

12. A process for producing a coated substrate (4) as defined in any of claims 1 to 10, comprising the steps of:
a) providing a substrate (4), preferably as defined in claim 10,
b) generating a transparent interdigital structure (1a, 1b), preferably as defined in either of claims 3 and 8, and
c) coating the substrate (4) and the interdigital structure (1a, 1b) with a transparent outer layer (6), preferably as defined in either of claims 2 and 9.

13. The process of claim 12, wherein step b) takes place at least partly by means of an ablation process, and/or material conversion, preferably by means of a laser process, preference being given to using an NdYAG laser.

14. The process of claim 12 or 13, wherein after step a) and before step c) an interlayer (5) is applied, preferably as defined in claim 9.

15. The process of any of claims 12 to 14, wherein step c) takes place by a spraying, immersion, PVD, CVD or PE-CVD process, preferably by a PVD, CVD or PE-CVD process.
